(19) United States
(12) Patent Application Publication
(10) Pub. No.: US 2021/0312462 A1
(43) Pub. Date: Oct. 7, 2021

(54) METHOD, APPARATUS, AND DEVICE FOR TRANSFERRING VIRTUAL RESOURCES ACROSS DOMAINS

(71) Applicant: Alipay Labs (Singapore) Pte. Ltd., Singapore (SG)

(72) Inventor: Jiankang SUN, HANGZHOU (CN)

(21) Appl. No.: 17/354,569

(22) Filed: Jun. 22, 2021

(30) Foreign Application Priority Data
Jul. 15, 2020 (CN) 202010681948.3

(51) Int. Cl. G06Q 20/40; G06Q 20/32; G06Q 20/10

(52) U.S. Cl. CPC G06Q 20/4016; G06Q 20/105; G06Q 20/3276; G06Q 20/4037

(57) ABSTRACT

A method includes: generating, by a first terminal in a first domain, first virtual resource information according to virtual resource information provided by a first user. The first virtual resource information includes a quantity of a virtual resource, information of the first user, and information of a virtual resource receiving party. The first virtual resource information is transmitted to a cloud server, causing the cloud server to generate the second virtual resource information according to the first virtual resource information and return the second virtual resource information to the first terminal. The second virtual resource information at least includes the first virtual resource information and an order number. The second virtual resource information is sent to a second terminal, so that the second terminal transfers, based on the second virtual resource information, virtual resource corresponding to the quantity of the virtual resource to the virtual resource receiving party.

### CROSS REFERENCE TO RELATED APPLICATIONS

This application claims priority to and benefits of Chinese Patent Application No. 202010681948.3 filed on Jul. 15, 2020, the content of which is incorporated herein by reference in its entirety.

### TECHNICAL FIELD

The present specification relates to the field of computer technology, and in particular to a method, an apparatus, and a device for transferring virtual resources across domains.

### BACKGROUND

With the development of the Internet and the improvement of living standards, applications of transferring virtual resources are increasingly common. In some virtual resource transfer services, especially in cross-domain virtual resource transfer services, there may be a first user who can fill in virtual resource information in a form needed for the transfer, but does not have resources required for cross-domain virtual resource transfer, and a second user (who may be a relative or a friend of the first user) has the resources required for cross-domain virtual resource transfer, but does not know how to fill in the virtual resource information in a form needed for the transfer. Currently, in the cross-domain virtual resource transfer services, the same user generally completes a cross-domain virtual resource transfer, that is, the first user and the second user are the same person.

In this type of cross-domain virtual resource transfer scenarios, a virtual resource owner cannot fill in virtual resource information due to language barriers, or a user can fill in virtual resource information but does not have enough virtual resources, which leads to a service scenario where filling in virtual resource information and transferring virtual resource are bifurcated. There is a demand for novel method for transferring virtual resources across domains.

### SUMMARY OF THE INVENTION

The embodiments of the present specification provide a method, an apparatus, and a device for transferring virtual resources across domains, which are used to solve the following technical problem: in scenarios of transferring virtual resources across domains, where filling in virtual resource information and transferring virtual resource are bifurcated.

To solve the above technical problems, the embodiments of the present specification are implemented as follows.

The method for transferring virtual resources across domains provided by the embodiments of the present specification includes the following operations.

A first terminal in a first domain generates first virtual resource information according to virtual resource information provided by a first user. The first virtual resource information at least includes a quantity of a to-be-transferred virtual resource, information of the first user, and information of a virtual resource receiving party. The virtual resource receiving party is located in the first domain.

The first terminal transmits the first virtual resource information to a cloud server located in a second domain, causing the cloud server to generate the second virtual resource information according to the first virtual resource information and return the second virtual resource information to the first terminal. The second virtual resource information at least includes the first virtual resource information and an order number. The cloud server is provided by a service provider having functions of transferring virtual resources across domains.

The first terminal sends the second virtual resource information to a second terminal of a second user located in the second domain, so that the second terminal transfers, based on the second virtual resource information, the to-be-transferred virtual resource corresponding to the quantity of the to-be-transferred virtual resource to the virtual resource receiving party.

In some embodiments, the first terminal sending the second virtual resource information to the second terminal, so that the second terminal transfers, based on the second virtual resource information, the virtual resource corresponding to the quantity of the virtual resource to the virtual resource receiving party includes: receiving, by the second terminal of the second user, the second virtual resource information sent by the first terminal. The second terminal sends a resource transfer request to a server where virtual resources of the second user are located, causing the server where the virtual resources of the second user are located to select the virtual resource from the virtual resources of the second user and to transfer the virtual resource to the cloud server. The second terminal generates third virtual resource information to complete a first transfer of the virtual resource. The third virtual resource information includes identity information of the second user. If the second virtual resource information or the third virtual resource information passes risk verification of the cloud server, the cloud server transfers the virtual resource to the virtual resource receiving party to complete a second transfer of the virtual resource.

In some embodiments, the method further includes: performing risk verification on the first virtual resource information at the cloud server; and in response to that the first virtual resource information passes the risk verification, generating, by the cloud server, the second virtual resource information according to the first virtual resource information and returning, by the cloud server, the second virtual resource information to the first terminal.

In some embodiments, the method further includes: in response to that the first virtual resource information fails the risk verification at the cloud server, returning a risk verification result to the first terminal to provide a security reminder to the first user corresponding to the first terminal.

In some embodiments, the second virtual resource information has a preset format, and the preset format is used for the second user to transfer virtual resource to the virtual resource receiving party.

In some embodiments, the second virtual resource information or the third virtual resource information passing the risk verification of the cloud server includes: sending, by the first terminal, the second virtual resource information to the cloud server in a form of a link or a QR code, and/or sending, by the second terminal, the third virtual resource information to the cloud server in a form of a link or a QR code, and performing, by the cloud server, the risk verification on the second virtual resource information or the third virtual resource information.

In some embodiments, the virtual resource includes monetary resource.

The embodiments of the present specification also provide a first terminal in a first domain. The first terminal includes at least one processor, and a memory communicatively connected with the at least one processor. The memory stores instructions executable by the at least one processor to cause the first terminal to perform the following operations.

The first terminal generates first virtual resource information according to virtual resource information provided by a first user. The first virtual resource information at least includes a quantity of a to-be-transferred virtual resource, information of the first user, and information of a virtual resource receiving party. The virtual resource receiving party is located in the first domain.

The first terminal transmits the first virtual resource information to a cloud server located in a second domain, causing the cloud server to generate the second virtual resource information according to the first virtual resource information and return the second virtual resource information to the first terminal. The second virtual resource information at least includes the first virtual resource information and an order number. The cloud server is provided by a service provider having functions of transferring virtual resources across domains.

The first terminal sends the second virtual resource information to a second terminal of a second user located in the second domain, so that the second terminal transfers, based on the second virtual resource information, the to-be-transferred virtual resource corresponding to the quantity of the to-be-transferred virtual resource to the virtual resource receiving party.

The embodiments of the present specification also provide one or more non-transitory computer-readable media configured with instructions executable by a virtual resource transfer system to cause the virtual resource transfer system to perform operations including: generating, by a first terminal in a first domain, first virtual resource information according to virtual resource information provided by a first user, wherein the first virtual resource information at least includes a quantity of a virtual resource, information of the first user, and information of a virtual resource receiving party to receive the virtual resource, and the virtual resource receiving party is located in the first domain; transmitting, by the first terminal, the first virtual resource information to a cloud server located in a second domain, causing the cloud server to generate second virtual resource information according to the first virtual resource information and return the second virtual resource information to the first terminal, wherein the second virtual resource information at least includes the first virtual resource information and an order number; and sending, by the first terminal, the second virtual resource information to a second terminal of a second user located in the second domain, so that the second user transfers, based on the second virtual resource information, virtual resource corresponding to the quantity of the virtual resource to the virtual resource receiving party.

The techniques disclosed herein solve the problem of scenarios of transferring virtual resources across domains, where filling in virtual resource information and transferring virtual resource are bifurcated.

### BRIEF DESCRIPTION OF THE DRAWINGS

To more clearly describe the technical solutions of the embodiments of the present specification or of the current technologies, the accompanying drawings to be used in the description of the embodiments or the current technologies will be briefly described below. Apparently, the accompanying drawings in the description below are merely some of the embodiments of the present specification. Other drawings may be obtained by one of ordinary skill in the art without creative effort according to these accompanying drawings.

FIG. 1 is a flow chart of a method for transferring virtual resources across domains provided by the embodiments of the present specification;

FIG. 2 is a flow chart of another method for transferring virtual resources across domains provided by the embodiments of the present specification;

FIG. 3 is a flow chart of another method for transferring virtual resources across domains provided by the embodiments of the present specification;

FIG. 4 is a flow chart of another method for transferring virtual resources across domains provided by the embodiments of the present specification;

FIG. 5A, FIG. 5B, FIG. 5C, and FIG. 5D are block diagrams of methods for transferring virtual resources across domains provided by the embodiments of the present specification; and

FIG. 6 is a schematic diagram of an apparatus for transferring virtual resources across domains provided by the embodiments of the present specification.

### DETAILED DESCRIPTION

To enable those skilled in the art to better understand the technical solutions of the present specification, the technical solutions of the embodiments of the present specification will be completely and thoroughly described below with reference to the accompanying drawings in the embodiments of the present specification. Apparently, the described embodiments are merely some, but not all, embodiments of the present application. All other embodiments obtained, based on some embodiments of the present specification, by one of ordinary skill in the art without creative effort shall fall within the protection scope of the present application.

With the globalization of economy and finance and increasingly progressed opening of China to the outside world, cross-domain virtual resource transfer services are becoming more and more extensive. However, in the current cross-domain virtual resource transfer, for example, Chinese A studying in the United States needs to transfer virtual resources to pay tuition, but A does not have enough virtual resources to pay the tuition. On the other hand, A's family or friends have enough virtual resources. The problem is that although A's family members or friends have enough virtual resources to pay A's tuition, they do not use a non-native language, such as English, to fill in information about virtual resources in a form needed for making the transfer. Since A can fill in the information about virtual resources, A can fill in the virtual resource-related information in this case, but the payment of the virtual resource has to be completed by A's family or friends. That is to say, the completion of the virtual resource-related information and the payment of the virtual resources are filled in by different users, where one or more of them have difficulty to do.

As another example, in a medical scenario, a user who can fill in information about virtual resources in a non-native language does not have enough virtual resources to pay medical expenses. On the other hand, his/her family members or friends have enough virtual resources to pay the medical expenses, but have difficulties in filling in or even cannot fill in information related to virtual resources due to language differences. Therefore, in order to realize the transfer of virtual resources across domains, one user can fill in the information related to virtual resources, and another user pays the virtual resources, thereby realizing the transfer of virtual resources across domains.

In the process of cross-domain virtual resource transfer, there may also be security issues. Therefore, in order to ensure the security of cross-domain virtual resource transfer, it is necessary to further identify risks of the cross-domain virtual resource transfer.

In view of the above issues, a novel method for transferring virtual resources across domains is needed, so as to solve the problem that a virtual resource owner cannot fill in virtual resource information due to language barriers, or a user can complete virtual resource information but does not have enough virtual resources, which leads to a service scenario where filling in virtual resource information and transferring virtual resource are bifurcated.

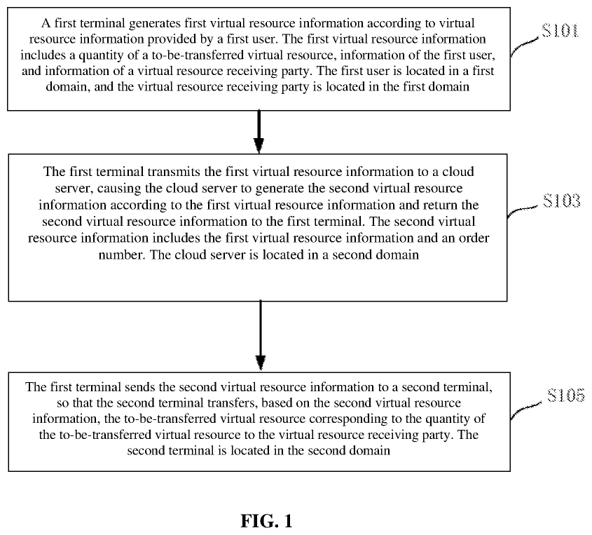

FIG. 1 is a flow chart of a method for transferring virtual resources across domains provided by the embodiments of the present specification, and the method includes the following steps.

At Step S101, a first terminal generates first virtual resource information according to virtual resource information provided by a first user. The first virtual resource information at least includes a quantity of a to-be-transferred virtual resource, information of the first user, and information of a virtual resource receiving party. The first user is located in a first domain. The virtual resource receiving party is located in the first domain.

In the embodiments of the present specification, the first terminal may be a device or terminal with a virtual resource transfer function. The first terminal may be a user's mobile device, computer, server, smart phone, etc. that has an APP, or an application operating system with a cross-domain virtual resource transfer function at an offline counter of an institution with a cross-domain virtual resource transfer function. The type of the first terminal does not constitute a limitation to the present application.

In the embodiments of the present specification, the first user is mainly used to provide virtual resource-related information in the process of cross-domain virtual resource transfer, and to provide the first virtual resource information at the first terminal. The first user is generally able to provide the first virtual resource information, but is not a holder of the virtual resources, or cannot provide a sufficient quantity of the to-be-transferred virtual resource. Therefore, although the first user can provide the first virtual resource information, the first user cannot realize the transfer of virtual resources across domains. The first user can provide virtual resource information in a specified language according to the requirement of cross-domain virtual resource transfer. In some embodiments, the designated language is generally a non-native language. The designated language may be English, Japanese, German, etc., and the type of the designated language does not constitute a limitation on the present application.

In the embodiments of the present specification, the first user is used to provide the first terminal with the first virtual resource information. The content of the first virtual resource information at least includes: the quantity of the to-be-transferred virtual resource, information of the first user, and information of the virtual resource receiving party. The information of the first user may include an account of the first user and a name of the first user. The information of the virtual resource receiving party may include one or more of a name of the virtual resource receiving party, an account of the virtual resource receiving party, and an address of the virtual resource receiving party. The content of the first virtual resource information does not constitute a limitation to the present specification.

In the embodiments of the present specification, the virtual resources can be money, and the content of the first virtual resource information at least includes: an amount of money to be transferred, information of the first user, and information of a money receiving party. Here, the amount of money to be transferred is an amount of money in a designated currency, and the first user information includes: one or more of a remitter account, a remitter name, and a remitter address. The information of the money receiving party includes one or more of a bank identifier of a beneficiary bank, a name of the beneficiary bank, an address of the beneficiary bank, a beneficiary account number, a beneficiary account name, and a beneficiary address.

At Step S103, the first terminal transmits the first virtual resource information to a cloud server, causing the cloud server to generate the second virtual resource information according to the first virtual resource information and return the second virtual resource information to the first terminal. The second virtual resource information at least includes the first virtual resource information and an order number, the cloud server is provided by a service provider having functions of transferring virtual resources across domains, and the cloud server is located in a second domain; and

In the embodiments of the present specification, the cloud server is generally provided by a service provider with functions of transferring virtual resources across domains. In one example, it can be provided by a third-party cross-domain virtual resource transfer agency or a licensed agency. In the embodiments of the present specification, if the virtual resources are money, the cloud server can be provided by a service provider with the function of cross-domain currency transfer. In one example, it can be provided by a financial institution with the function of cross-domain money transfer or a licensed institution.

In the embodiments of the present specification, the cloud server is generally located in the second domain, that is, located in the second domain where the second user is located. The transfer of virtual resources is from the second domain to the first domain, where the first domain and the second domain are located in different areas and belong to cross-domain areas.

After receiving the first virtual resource information sent by the first terminal, the cloud server generates the second virtual resource information based on the first virtual resource information according to a preset format. Since the second virtual resource information is generated based on the first virtual resource information, the second virtual resource information may at least include some or all the information of the first virtual resource information. In addition, the second virtual resource information may at least also include an order number, so the second virtual resource information may at least include the first virtual resource information and the order number. Other information may be included in the second virtual resource information. The order number may be an identifier generated by the cloud server for identifying first virtual resource information sent by the first terminal.

Since the cloud server may be provided by different service providers capable of cross-domain virtual resource transfer, the preset formats provided by different service providers capable of cross-domain virtual resource transfer may be different. Therefore, the formats of the second virtual resource information may also be different. The second virtual resource information is generated according to a preset format, or in other words, has a preset format, and the preset format is used by the second terminal to transfer the virtual resources to the virtual resource receiving party. The specific format of the second virtual resource information does not constitute a limitation to the present application.

At Step S105, the first terminal sends the second virtual resource information to a second terminal, so that the second terminal transfers, based on the second virtual resource information, the to-be-transferred virtual resource corresponding to the quantity of the to-be-transferred virtual resource to the virtual resource receiving party, where the second terminal is located in the second domain.

In the embodiments of the present specification, the second terminal is a terminal where the second user is located or a terminal where the second user logs in. The second user is mainly used to provide virtual resources during the process of cross-domain virtual resource transfer, and is a holder of virtual resources to pay the virtual resources needed in the process of cross-domain virtual resource transfer so as to perform the virtual resource transfer. The second user can generally provide virtual resources, but cannot provide virtual resource information due to reasons such as language barriers or other constrains. Therefore, the second user can provide virtual resources, but cannot alone realize the transfer of virtual resources across domains.

In the embodiments of the present specification, the second user pays the virtual resources by paying at the second terminal where the second user is located.

In the embodiments of the present specification, the second terminal is a device or terminal with a virtual resource transfer function. The second terminal may be a user's mobile device, computer, server, smart phone, etc. that has an APP, or may be an application operating system with a cross-domain virtual resource transfer function at an offline counter of an institution with a cross-domain virtual resource transfer function. The type of the second terminal does not constitute a limitation to the present application. It should be noted that in the embodiments of the present specification, the first terminal and the second terminal may be terminals of the same type or may be terminals of different types. That is, the first terminal and the second terminal may both be a mobile device with an APP, or an application operating system with a cross-domain virtual resource transfer function at an offline counter of an institution with a cross-domain virtual resource transfer function.

In the embodiments of the present specification, the first terminal sending the second virtual resource information to a second terminal, so that the second terminal transfers, based on the second virtual resource information, the to-be-transferred virtual resource corresponding to the quantity of the to-be-transferred virtual resource to the virtual resource receiving party includes: the second terminal of the second user receives the second virtual resource information sent by the first terminal; the second terminal sends a resource transfer request to a server where virtual resources of the second user are located, causing the server where the virtual resources of the second user are located to select the to-be-transferred virtual resource from the virtual resources of the second user and to transfer the to-be-transferred virtual resource to the cloud server, and the second terminal generates third virtual resource information to complete a first transfer of the to-be-transferred virtual resource, wherein the third virtual resource information includes identity information of the second user; and if the second virtual resource information and/or the third virtual resource information passes risk verification of the cloud server, the cloud server transferring the to-be-transferred virtual resource to the virtual resource receiving party to complete a second transfer of the to-be-transferred virtual resource.

In some embodiment, after the first terminal sends the second virtual resource information to the second terminal and in the process that the second terminal transfers, based on the second virtual resource information, the to-be-transferred virtual resource corresponding to the quantity of the to-be-transferred virtual resource to the virtual resource receiving party, there may be a time difference between receiving the second virtual resource information and transferring the virtual resources. After receiving the second virtual resource information, the second terminal where the second user is located may transfer the virtual resources within a preset time. In general, the preset time does not exceed one week, and the length of the preset time does not constitute a limitation to the present application.

The method provided by the embodiments of the present specification can solve the problem that a virtual resource holder cannot fill in virtual resource information due to language barriers, or a user can fill in virtual resource information but does not have enough virtual resources, which leads to a service scenario where filling in virtual resource information and transferring virtual resource are bifurcated.

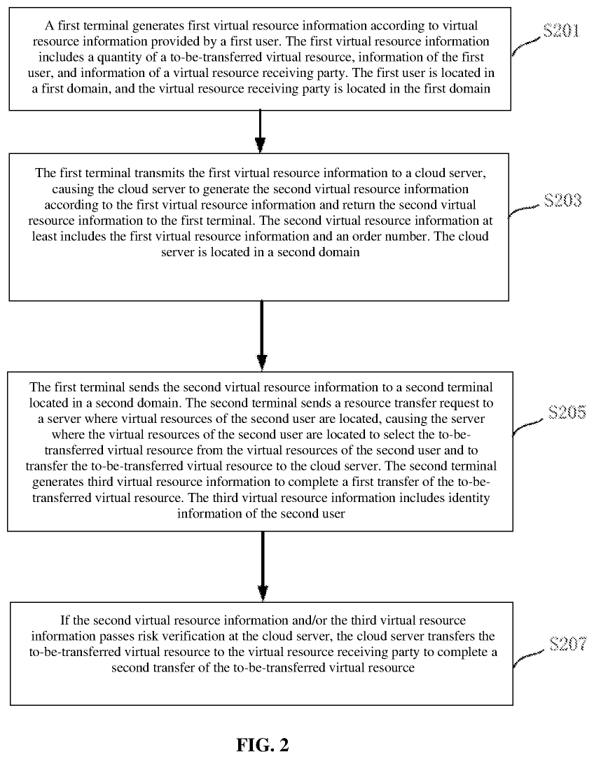

Since there may be risks such as unauthorized virtual resource transfer during a process of cross-domain virtual resource transfer, in order to ensure the security of the cross-domain virtual resource transfer, the embodiments of the present specification provide another cross-domain virtual resource transfer method. FIG. 2 is a flow chart of another method for transferring virtual resources across domains provided by the embodiments of the present specification. The method for transferring virtual resources across domains includes the following operations.

At Step S201, a first terminal generates first virtual resource information according to virtual resource information provided by a first user. The first virtual resource information at least includes a quantity of a to-be-transferred virtual resource, information of the first user, and information of a virtual resource receiving party. The first user is located in a first domain, and the virtual resource receiving party is located in the first domain.

At Step S203, the first terminal transmits the first virtual resource information to a cloud server, causing the cloud server to generate the second virtual resource information according to the first virtual resource information and return the second virtual resource information to the first terminal The second virtual resource information at least includes the first virtual resource information and an order number. The cloud server is provided by a service provider having functions of transferring virtual resources across domains, and the cloud server is located in a second domain.

At Step S205, the first terminal sends the second virtual resource information to a second terminal. The second terminal sends a resource transfer request to a server where virtual resources of the second user are located, causing the server where the virtual resources of the second user are located to select the to-be-transferred virtual resource from the virtual resources of the second user and to transfer the to-be-transferred virtual resource to the cloud server. The second terminal generates third virtual resource information to complete a first transfer of the to-be-transferred virtual resource from the server where virtual resources of the second user are located to the cloud server. The third virtual resource information includes identity information of the second user.

In the embodiments of the present specification, the second terminal where the second user is located transfers the to-be-transferred virtual resource corresponding to the quantity of to-be-transferred virtual resource to the virtual resource receiving party based on the second virtual resource information. In order to ensure the security of cross-domain resource transfer, for the first transfer of to-be-transferred virtual resource, the virtual resource(s) can be first transferred from the server where virtual resources of the second user are located to the cloud server for the cloud server to save the to-be-transferred virtual resource. After the risk verification is passed at the cloud server, the to-be-transferred virtual resource are transferred to the virtual resource receiving party.

In the embodiments of the present specification, the third virtual resource information is generated based on the second virtual resource information, and the third virtual resource information includes the identity information of the second user, so that the cloud server can perform risk verification on the second user.

At Step S207, if the second virtual resource information and/or the third virtual resource information passes risk verification of the cloud server, the cloud server transfers the to-be-transferred virtual resource to the virtual resource receiving party to complete a second transfer of the to-be-transferred virtual resource.

In the embodiments of the present specification, in order to ensure the security of cross-domain virtual resource transfer, the first terminal sends the second virtual resource information to the cloud server in the form of a link or a QR code, and/or the second terminal sends the third virtual resource information to the cloud server in the form of a link or a QR code. After the cloud server receives the virtual resources transferred by the second terminal, risk verification further needs to be performed on the second virtual resource information and/or the third virtual resource information received by the cloud server.

In the embodiments of the present specification, the cloud server performs risk verification on the second virtual resource information and/or the third virtual resource information, which is to identify the content in the second virtual resource information and/or the third virtual resource information to ensure the security of the second virtual resource information and/or the third virtual resource information, thereby ensuring the security of the cross-domain virtual resource transfer.

In the embodiments of the present specification, the risk verification performed by the cloud server on the second virtual resource information and/or the third virtual resource information is completed by a third-party authority.

In some embodiments, the prerequisite for the second transfer of the to-be-transferred virtual resource is that the second virtual resource information and/or the third virtual resource information passes risk verification by the cloud server. If the second virtual resource information and/or the third virtual resource information does not pass risk verification by the cloud server, the to-be-transferred virtual resource on the cloud server will be returned to the second terminal, that is, the transfer of the virtual resources cannot be completed. Alternatively, the cloud server returns the result that the second virtual resource information and/or the third virtual resource information fails risk verification at the cloud server to the second terminal, and further determines whether to perform risk verification again or directly terminate the transfer of the virtual resources. The exemplary processing method after the second virtual resource information and/or the third virtual resource information fails risk verification at the cloud server does not constitute a limitation to the present application.

The method provided by the embodiments of the present specification can solve the problem that a virtual resource holder cannot fill in virtual resource information due to language barriers, or a user can fill in virtual resource information but does not have enough virtual resources, which leads to a service scenario where filling in virtual resource information and transferring virtual resource are bifurcated. Since the risk verification is performed during the process, the security of cross-domain virtual resource transfer can be further ensured.

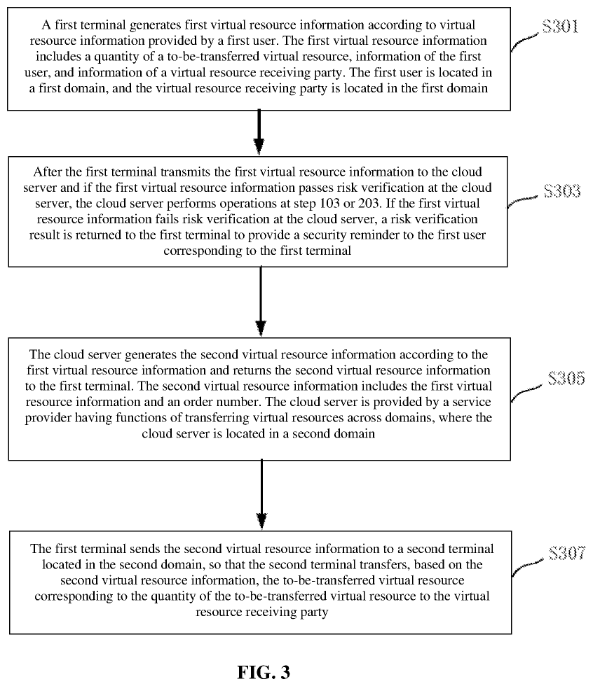

In order to ensure the security of cross-domain virtual resource transfer, the embodiments of the present specification provides another method for transferring virtual resources across domains. FIG. 3 is a flow chart of another method for transferring virtual resources across domains provided by the embodiments of the present specification. The method for transferring virtual resources across domains includes the following operations.

At Step S301, a first terminal generates first virtual resource information according to virtual resource information provided by a first user. The first virtual resource information at least includes a quantity of a to-be-transferred virtual resource, information of the first user, and information of a virtual resource receiving party. The first user is located in a first domain, and the virtual resource receiving party is located in the first domain.

At Step S303, after the first terminal transmits the first virtual resource information to the cloud server and if the first virtual resource information passes risk verification at the cloud server, the cloud server proceeds to perform generating the second virtual resource information according to the first virtual resource information and returning the second virtual resource information to the first terminal as explained at steps 103 and 203.

If the first virtual resource information fails risk verification at the cloud server, the cloud server returns a risk verification result to the first terminal to provide a security reminder to the first user corresponding to the first terminal.

In the embodiments of the present specification, in order to ensure the security of the cross-domain virtual resource transfer, after receiving the first virtual resource information sent by the first terminal, the cloud server first needs to perform risk verification on the first virtual resource information to ensure the security of the first virtual resource first information.

In the embodiments of the present specification, the cloud server performs risk verification on the first virtual resource information, which is to identify the content in the first virtual resource information to ensure the security of the first virtual resource information, thereby ensuring the security of the cross-domain virtual resource transfer.

In an exemplary implementation process, risk verification is performed on the first virtual resource information, including a quantity of a to-be-transferred virtual resource, information of the first user, and information of a virtual resource receiving party. In one example, risk verification is performed on one or more of an account of the first user, a name of the first user, a name of the virtual resource receiving party, an account of the virtual resource receiving party, and an address of the virtual resource receiving party.

In the embodiments of the present specification, the virtual resources are money, and the risk verification on the first virtual resource information is to identify an amount of money to be transferred, information of the first user, and information of a money receiving party. In one example, risk verification is performed on one or more of a remitter account, a remitter name, a remitter address, a bank number of a beneficiary bank, a name of the beneficiary bank, an address of the beneficiary bank, a beneficiary account number, a beneficiary account name, and a beneficiary address.

At Step S305, the cloud server generates the second virtual resource information according to the first virtual resource information and returns the second virtual resource information to the first terminal. The second virtual resource information at least includes the first virtual resource information and an order number. The cloud server is provided by a service provider having functions of transferring virtual resources across domains. The cloud server is located in a second domain.

At Step S307, the first terminal sends the second virtual resource information to a second terminal, so that the second terminal transfers, based on the second virtual resource information, the to-be-transferred virtual resource corresponding to the quantity of the to-be-transferred virtual resource to the virtual resource receiving party, where the second terminal is located in the second domain.

The method for transferring virtual resources across domains provided by the embodiments of the present specification includes a method of performing risk verification on the first virtual resource information, which can solve the problem that a virtual resource holder cannot fill in virtual resource information due to language barriers, or a user can fill in the virtual resource information but does not have enough virtual resources, which leads to a service scenario where filling in the virtual resource information is separated from transferring the virtual resource. Moreover, the security of the cross-domain virtual resource transfer can be guaranteed.

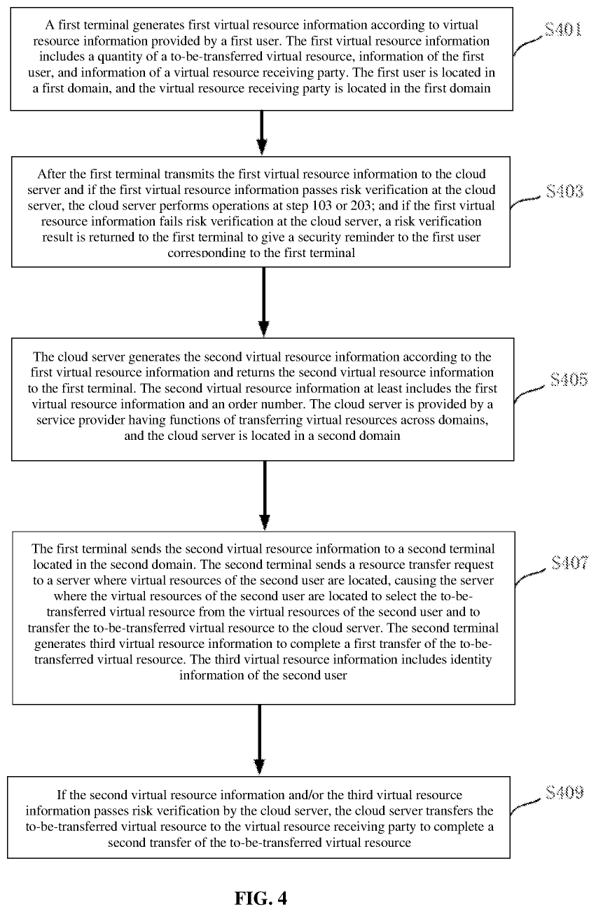

In order to ensure the security of cross-domain virtual resource transfer, the embodiments of the present specification provide another method for transferring virtual resources across domains. FIG. 4 is a flow chart of another method for transferring virtual resources across domains provided by the embodiments of the present specification. The method for transferring virtual resources across domains includes the following operations

At Step S401, a first terminal generates first virtual resource information according to virtual resource information provided by a first user. The first virtual resource information at least includes a quantity of a to-be-transferred virtual resource, information of the first user, and information of a virtual resource receiving party. The first user is located in a first domain, and the virtual resource receiving party is located in the first domain;

At Step S403, after the first terminal transmits the first virtual resource information to the cloud server and if the first virtual resource information passes risk verification at the cloud server, the cloud server proceeds to perform generating the second virtual resource information according to the first virtual resource information and returning the second virtual resource information to the first terminal as explained at steps 103 and 203.

If the first virtual resource information fails risk verification at the cloud server, the cloud server returns a risk verification result to the first terminal to provide a security reminder to the first user corresponding to the first terminal.

At Step S405, the cloud server generates the second virtual resource information according to the first virtual resource information and returns the second virtual resource information to the first terminal. The second virtual resource information at least includes the first virtual resource information and an order number. The cloud server is provided by a service provider having functions of transferring virtual resources across domains. The cloud server is located in a second domain.

At Step S407, the first terminal sends the second virtual resource information to a second terminal. The second terminal sends a resource transfer request to a server where virtual resources of the second user are located, causing the server where the virtual resources of the second user are located to select the to-be-transferred virtual resource from the virtual resources of the second user and to transfer the to-be-transferred virtual resource to the cloud server. The second terminal generates third virtual resource information to complete a first transfer of the to-be-transferred virtual resource from the server where virtual resources of the second user are located to the cloud server. The second terminal is located in the second domain. The third virtual resource information includes identity information of the second user.

At Step S409, if the second virtual resource information and/or the third virtual resource information passes risk verification by the cloud server, the cloud server transfers the to-be-transferred virtual resource to the virtual resource receiving party to complete a second transfer of the to-be-transferred virtual resource.

The method for transferring virtual resources across domains provided by the embodiments of the present specification includes a method of performing risk verification on the first virtual resource information and a method of further performing risk verification on the second virtual resource information and/or the third virtual resource information, which can solve the problem that a virtual resource holder cannot fill in virtual resource information due to language barriers, or a user can fill in the virtual resource information but does not have enough virtual resources, which leads to a service scenario where filling in the virtual resource information is separated from transferring the virtual resource. Moreover, the security of the cross-domain virtual resource transfer can be guaranteed. Since risk verification is performed twice, the security of cross-domain virtual resource transfer is higher, leading to a more secured transfer.

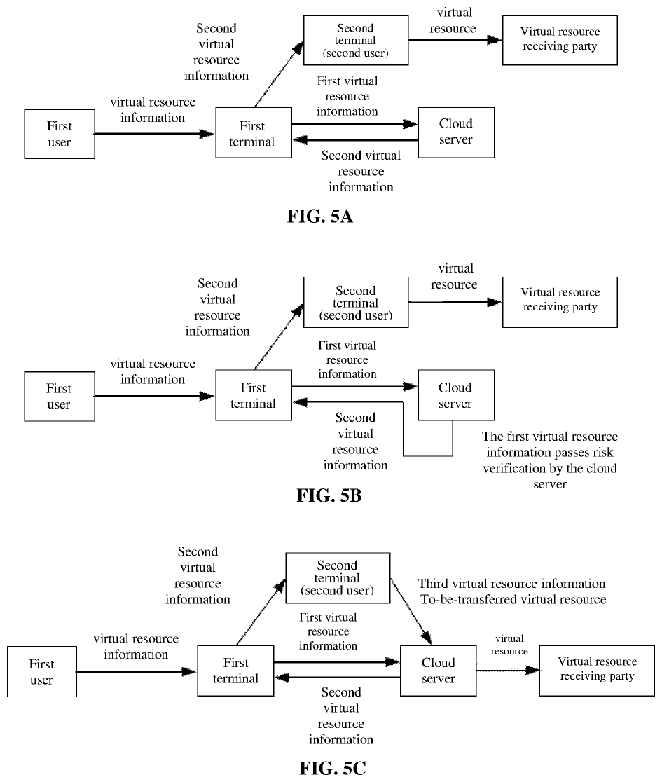

FIG. 5A-5D are block diagrams of methods for transferring virtual resources across domains provided by the embodiments of the present specification.

In one example, as shown in FIG. 5A, after receiving virtual resource information provided by a first user, a first terminal generates first virtual resource information. The first terminal further transmits the first virtual resource information to a cloud server, and the cloud server generates second virtual resource information based on the first virtual resource information. The cloud server then returns the second virtual resource information to the first terminal. The first terminal further sends the second virtual resource information to a second terminal. The second terminal where a second user is located transfers to-be-transferred virtual resource to a virtual resource receiving party according to the second virtual resource information, so as to complete the transfer of the virtual resources.

As shown in FIG. 5B, after receiving virtual resource information provided by a first user, a first terminal generates first virtual resource information. The first terminal further transmits the first virtual resource information to a cloud server. The cloud server performs risk verification on the received first virtual resource information. After the first virtual resource information passes risk verification by the cloud server, the cloud server generates second virtual resource information based on the first virtual resource information. The cloud server then returns the second virtual resource information to the first terminal. The first terminal further sends the second virtual resource information to a second terminal. The second terminal where a second user is located transfers to-be-transferred virtual resource to a virtual resource receiving party according to the second virtual resource information, so as to complete the transfer of the virtual resources.

In one embodiment of the present specification, as shown in FIG. 5C, after receiving virtual resource information provided by a first user, a first terminal generates first virtual resource information. The first terminal further transmits the first virtual resource information to a cloud server, and the cloud server generates second virtual resource information based on the first virtual resource information. The cloud server then returns the second virtual resource information to the first terminal. The first terminal further sends the second virtual resource information to a second terminal. The second terminal where a second user is located transfers to-be-transferred virtual resource to the cloud server according to the second virtual resource information. In order to ensure the security of the virtual resource transfer, the cloud server performs risk verification on the second virtual resource information and/or third virtual resource information. After the second virtual resource information and/or the third virtual resource information passes risk verification at the cloud server, the cloud server transfers the to-be-transferred virtual resource to a virtual resource receiving party.

In one embodiment of the present specification, as shown in FIG. 5D, after receiving virtual resource information provided by a first user, a first terminal generates first virtual resource information. The first terminal further transmits the first virtual resource information to a cloud server. The cloud server performs risk verification on the received first virtual resource information. After the first virtual resource information passes risk verification by the cloud server, the cloud server generates second virtual resource information based on the first virtual resource information. The cloud server then returns the second virtual resource information to the first terminal. The first terminal further sends the second virtual resource information to a second terminal. The second terminal where a second user is located transfers to-be-transferred virtual resource to the cloud server according to the second virtual resource information. In order to ensure the security of the virtual resource transfer, the cloud server performs risk verification on the second virtual resource information and/or third virtual resource information. After the second virtual resource information and/or the third virtual resource information passes risk verification by the cloud server, the cloud server transfers the to-be-transferred virtual resource to a virtual resource receiving party.

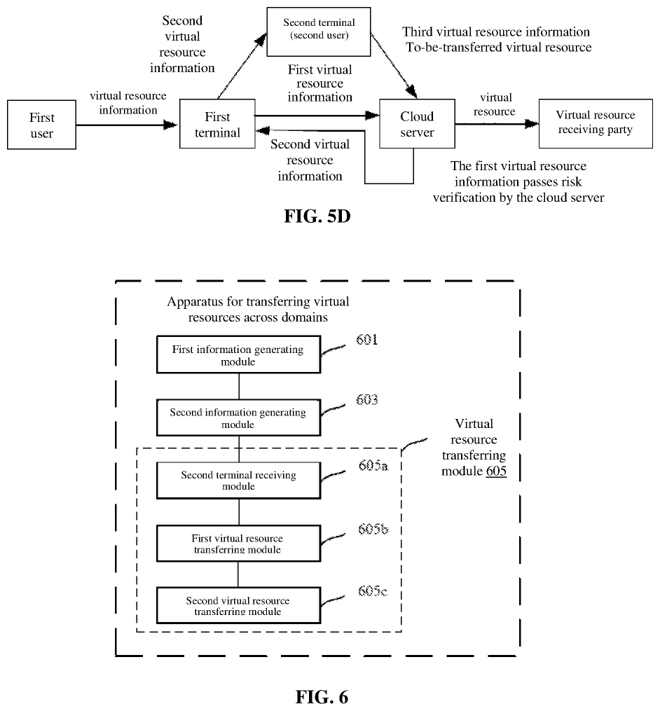

The above content describes in detail methods for transferring virtual resources across domains. Correspondingly, the present specification also provides an apparatus for transferring virtual resources across domains, as shown in FIG. 6. FIG. 6 is a schematic diagram of an apparatus for transferring virtual resources across domains provided by the embodiments of the present specification. The apparatus for transferring virtual resources across domains includes: a first information generating module 601, a second information generating module 603, and a virtual resource transferring module 605.

A first information generating module 601 in configured to cause a first terminal to generate first virtual resource information according to virtual resource information provided by a first user. The first virtual resource information at least includes a quantity of a to-be-transferred virtual resource, information of the first user, and information of a virtual resource receiving party. The first user is located in a first domain, and the virtual resource receiving party is located in the first domain.

The second information generating module 603 in configured to cause the first terminal to transmit the first virtual resource information to a cloud server, causing the cloud server to generate the second virtual resource information according to the first virtual resource information and return the second virtual resource information to the first terminal. The second virtual resource information at least includes the first virtual resource information and an order number. The cloud server is provided by a service provider having functions of transferring virtual resources across domains, and the cloud server is located in a second domain.

The virtual resource transferring module 605 is configured to cause the first terminal to send the second virtual resource information to a second terminal, so that the second terminal transfers, based on the second virtual resource information, the to-be-transferred virtual resource corresponding to the quantity of the to-be-transferred virtual resource to the virtual resource receiving party, and the second terminal is located in the second domain.

Furthermore, the virtual resource transferring module 605 includes: a second terminal receiving module 605a, a first virtual resource transferring module 605b, and a second virtual resource transferring module 605c.

The second terminal receiving module 605a is configured to cause the second terminal of the second user to receive the second virtual resource information sent by the first terminal.

The first virtual resource transferring module 605b is configured to cause the second terminal to send a resource transfer request to a server where virtual resources of the second user are located, causing the server where the virtual resources of the second user are located to select the virtual resources to be transferred from the virtual resources of the second user and to transfer the virtual resources to be transferred to the cloud server. The second terminal generates third virtual resource information to complete a first transfer of the virtual resources to be transferred, where the third virtual resource information includes identity information of the second user.

The second virtual resource transferring module 605c is configured to cause, if the second virtual resource information and/or the third virtual resource information passes risk identification of the cloud server, the cloud server to transfer the virtual resources to be transferred to the virtual resource receiving party to complete a second transfer of the virtual resources to be transferred.

Furthermore, the first terminal generating the first virtual resource information according to the virtual resource information provided by the first user further includes the following operations.

If the first virtual resource information passes risk identification at the cloud server, the cloud server proceeds to perform generating the second virtual resource information according to the first virtual resource information and returning the second virtual resource information to the first terminal as explained at steps 103 and 203.

If the first virtual resource information fails risk identification at the cloud server, a risk identification result is returned to the first terminal to give a security reminder to the first user corresponding to the first terminal.

Furthermore, the second virtual resource information has a preset format, and the preset format is used for the second terminal to transfer virtual resources to the virtual resource receiving party.

Furthermore, the second virtual resource information and/or the third virtual resource information passing risk identification at the cloud server includes: the first terminal sends the second virtual resource information to the cloud server in the form of a link or a QR code, and/or the second terminal sends the third virtual resource information to the cloud server in the form of a link or a QR code, and the cloud server performs risk identification on the second virtual resource information and/or the third virtual resource information.

The embodiments of the present specification also provide an electronic device. The electronic device includes at least one processor and a memory communicatively connected with the at least one processor. The memory stores instructions executable by the at least one processor, and the instructions are executed by the at least one processor, causing the at least one processor to perform the following.

A first terminal generates first virtual resource information according to virtual resource information provided by a first user. The first virtual resource information at least includes a quantity of virtual resource to be transferred, information of the first user, and information of a virtual resource receiving party. The first user is located in a first domain, and the virtual resource receiving party is located in the first domain.

The first terminal transmits the first virtual resource information to a cloud server, causing the cloud server to generate the second virtual resource information according to the first virtual resource information and return the second virtual resource information to the first terminal. The second virtual resource information at least includes the first virtual resource information and an order number. The cloud server is provided by a service provider having functions of transferring virtual resources across domains. The cloud server is located in a second domain.

The first terminal sends the second virtual resource information to a second terminal, so that the second terminal transfers, based on the second virtual resource information, the virtual resources to be transferred corresponding to the quantity of the virtual resources to be transferred to the virtual resource receiving party, where the second terminal is located in the second domain.

The foregoing describes exemplary embodiments of the present specification. Other embodiments are within the scope of the appended claims. In some cases, the actions or steps described in the claims can be performed in a different order from those in the embodiments, and desired results can still be achieved. In addition, the processes depicted in the drawings do not necessarily require the shown order or sequential order to achieve the desired results. In some embodiments, multitasking and parallel processing are also possible or may be advantageous.

The various embodiments in the present specification are described in a progressive manner, and the same or similar parts between the various embodiments can be referred to mutually, and each embodiment focuses on differences from other embodiments. In particular, for the apparatus, electronic device, and non-volatile computer storage medium embodiments, since they are basically similar to the method embodiments, the description is relatively simple, and for related parts, reference may be made to the part of the description of the method embodiments.

The apparatus, electronic device, and non-volatile computer storage medium correspond to the methods in the embodiments of the present specification. Therefore, the apparatus, electronic device, and non-volatile computer storage medium also have beneficial technical effects similar to those of corresponding methods. The beneficial technical effects of the methods have been described in detail above, and therefore, the beneficial technical effects of the corresponding device, electronic device, and non-volatile computer storage medium will not be elaborated by the present application.

In the 1990s, improvements of a technology can be clearly distinguished between hardware improvements (for example, improvements to circuit structures, such as diodes, transistors, switches, etc.) or software improvements (improvements to method flows). However, with the development of technology, improvements of many method flows today can be regarded as direct improvements of a hardware circuit structure. Designers almost always obtain a corresponding hardware circuit structure by programming an improved method flow into a hardware circuit. Therefore, it cannot be said that an improvement of a method flow cannot be realized by a hardware entity module. For example, a programmable logic device (PLD) (such as a Field Programmable Gate Array (FPGA)) is such an integrated circuit whose logic function is determined by a user's programming of the device. A designer programs on his/her own to “integrate” a digital system onto one piece of PLD, who does not need to request a chip manufacturer to design and manufacture a dedicated IC chip. At present, moreover, this type of programming has mostly been implemented through “logic compiler” software, rather than manually manufacturing the IC chips. The logic compiler software is similar to a software compiler used for program development and writing, while a particular programming language must be used for writing source code prior to compiling, which is referred to as a Hardware Description Language (HDL). There is not just one, but many types of HDL, such as ABEL (Advanced Boolean Expression Language), AHDL (Altera Hardware Description Language), Confluence, CUPL (Cornell University Programming Language), HDCal, JHDL (Java Hardware Description Language), Lava, Lola, MyHDL, PALASM, RHDL (Ruby Hardware Description Language), etc. The most commonly used right now includes VHDL (Very-High-Speed Integrated Circuit Hardware Description Language) and Verilog. One of ordinary skill in the art should also be aware that it would be very easy to obtain a hardware circuit to implement a logic method flow by using the above HDLs to carry out a little bit logic programming on the method flow and program the method flow into an IC.

A controller may be implemented in any proper manner. For example, a controller may be in, for example, a form of a microprocessor or processor, as well as a computer readable medium that stores computer readable program code (e.g., software or firmware) capable of being executed by the (micro) processor, a logic gate, a switch, an Application Specific Integrated Circuit (ASIC), a programmable logic controller, and an embedded microcontroller. Examples of the controller include, but are not limited to, the following microcontrollers: ARC 625D, Atmel AT91SAM, Microchip PIC18F26K20, and Silicone Labs C8051F320. A memory controller may further be implemented as a part of control logic of a memory. One of ordinary skill in the art should also be aware that, in addition to that a controller is implemented in a manner of pure computer readable program code, it is totally feasible to perform logic programming on steps of a method to enable a controller to implement the same functions in a form of a logic gate, a switch, an ASIC, a programmable logic controller, an embedded microcontroller, etc. Therefore, such controller may be deemed as a hardware part, while devices comprised in the controller and configured to achieve various functions may also be deemed as a structure inside the hardware part. Alternatively, devices configured to achieve various functions may even be deemed as both software modules to implement a method and a structure inside a hardware part.

The system, apparatus, module, or unit described in the above embodiments may be implemented, for example, by a computer chip or entity, or implemented by a product having a function. A typical implementation device is a computer. In one example, a computer may be, for example, a personal computer, a laptop computer, a cellular phone, a camera phone, a smart phone, a personal digital assistant, a medium player, a navigation device, an email device, a game console, a tablet computer, a wearable device, or a combination of any of these devices.

For convenience of description, the above apparatus is divided into various units according to functions for description. Functions of the units may be implemented in one or more pieces of software and/or hardware when one or more embodiments of the present specification are implemented.

One of ordinary skill in the art should understand that the embodiments of the present specification may be provided as a method, a system, or a computer program product. Therefore, the embodiments of the present specification may be implemented as a complete hardware embodiment, a complete software embodiment, or an embodiment combing software and hardware. Moreover, the embodiments of the present specification may be in the form of a computer program product implemented on one or more computer usable storage media (including, but not limited to, a magnetic disk memory, CD-ROM, an optical memory, etc.) including computer usable program codes.

The present specification is described with reference to flow charts and/or block diagrams of the method, device (system), and computer program product according to the embodiments of the present specification. It should be understood that each process and/or block in the flow charts and/or block diagrams, and a combination of processes and/or blocks in the flow charts and/or block diagrams can be realized by computer program instructions. These computer program instructions can be provided to a processor of a general-purpose computer, a special-purpose computer, an embedded processor, or other programmable data processing devices to generate a machine, causing the instructions executed by the processor of the computer or other programmable data processing devices to generate an apparatus for implementing a function specified in one or more processes in the flow charts and/or in one or more blocks in the block diagrams.

These computer program instructions can also be stored in a computer-readable memory that can direct a computer or other programmable data processing devices to work in a particular manner, causing the instructions stored in the computer-readable memory to generate a manufactured article that includes an instruction apparatus. The instruction apparatus implements a function specified in one or more processes in the flow charts and/or in one or more blocks in the block diagrams.

These computer program instructions can also be loaded on a computer or other programmable data processing devices, causing a series of operational steps to be performed on the computer or other programmable devices, thereby generating computer-implemented processing. Therefore, the instructions executed on the computer or other programmable devices provide steps for implementing a function specified in one or more processes in the flow charts and/or in one or more blocks in the block diagrams.

In a typical configuration, a computation device includes one or more processors (CPUs), input/output interfaces, network interfaces, and a memory.

The memory may include non-transitory computer readable media, such as a volatile memory, a Random-Access Memory (RAM), and/or a non-volatile memory, e.g., a Read-Only Memory (ROM) or a flash RAM. The memory is an example of a computer readable medium.

Computer-readable media include permanent, volatile, mobile, and immobile media, which can implement information storage through any method or technology. The information may be computer-readable instructions, data structures, program modules, or other data. Examples of storage media of computers include, but are not limited to, Phase-change Random Access Memories (PRAMs), Static Random Access Memories (SRAMs), Dynamic Random Access Memories (DRAMs), other types of Random Access Memories (RAMs), Read-Only Memories (ROMs), Electrically Erasable Programmable Read-Only Memories (EEPROMs), flash memories or other memory technologies, Compact Disk Read-Only Memories (CD-ROMs), Digital Versatile Discs (DVDs) or other optical memories, magnetic cassettes, cassette and disk memories or other magnetic memory devices, or any other non-transmission media, which can be used for storing information accessible to a computation device. According to the definitions in the present specification, the computer-readable media do not include transitory media, such as modulated data signals and carriers.

It should be further noted that the terms of “including,” “comprising” or any other variants of the terms are intended to encompass a non-exclusive inclusion, causing a process, method, product, or device including a series of elements to not only include these elements, but also include other elements that are not clearly listed, or further include elements that are inherent to the process, method, product, or device. When there is no further restriction, elements defined by the statement “comprising one . . . ” do not exclude that a process, method, product, or device including the above elements further includes additional identical elements.

The present specification may be described in a regular context of a computer executable instruction that is executed by a computer, such as a program module. Generally, the program module includes a routine, a program, an object, a component, a data structure, etc. for executing a particular task or implementing a particular abstract data type. The present specification may also be practiced in distributed computing environments. In these distributed computing environments, remote processing devices connected via communication networks carry out tasks. In the distributed computing environments, a program module may be located in local and remote computer storage media, including storage devices.

The embodiments in the present specification are described in a progressive manner with each embodiment focused on differences from other embodiments, and the embodiments may be mutually referenced for identical or similar parts. In particular, the system embodiment is described in a relatively simple manner, as the system embodiment is substantially similar to the method embodiment. The description of the method embodiment may be referenced for related parts.

The above-described is merely embodiments of the present specification, which are not used to limit the present application. To one of ordinary skill in the art, the present application may have various modifications and changes. Any modification, equivalent substitution, or improvement made within the spirit and principle of the present application shall be encompassed by the claims of the present application.

1. A method for transferring virtual resources across domains, comprising:
generating, by a first terminal in a first domain, first virtual resource information according to virtual resource information provided by a first user, wherein the first virtual resource information at least includes a quantity of a virtual resource, information of the first user, and information of a virtual resource receiving party to receive the virtual resource, and the virtual resource receiving party is located in the first domain;
transmitting, by the first terminal, the first virtual resource information to a cloud server located in a second domain, causing the cloud server to generate second virtual resource information according to the first virtual resource information and return the second virtual resource information to the first terminal, wherein the second virtual resource information at least includes the first virtual resource information; and
sending, by the first terminal, the second virtual resource information to a second terminal of a second user located in the second domain, so that the second user transfers, based on the second virtual resource information, the virtual resource corresponding to the quantity of the virtual resource to the virtual resource receiving party.

2. The method according to claim 1, wherein the first terminal sending the second virtual resource information to the second terminal, so that the second terminal transfers, based on the second virtual resource information, virtual resource corresponding to the quantity of the virtual resource to the virtual resource receiving party comprises:
receiving, by the second terminal of the second user, the second virtual resource information sent by the first terminal;
sending, by the second terminal, a resource transfer request to a server where virtual resources of the second user are located, causing the server where the virtual resources of the second user are located to select the virtual resource from the virtual resources of the second user and to transfer the virtual resource to the cloud server, and generating, by the second terminal, third virtual resource information to complete a first transfer of the virtual resource, wherein the third virtual resource information includes identity information of the second user; and
if the second virtual resource information or the third virtual resource information passes risk verification of the cloud server, transferring, by the cloud server, the virtual resource to the virtual resource receiving party to complete a second transfer of the virtual resource.

3. The method according to claim 1, further comprising:
performing risk verification on the first virtual resource information at the cloud server; and
in response to that the first virtual resource information passes the risk verification, generating, by the cloud server, the second virtual resource information according to the first virtual resource information and returning, by the cloud server, the second virtual resource information to the first terminal.

4. The method according to claim 3, further comprising:
in response to that the first virtual resource information fails the risk verification at the cloud server, returning a risk verification result to the first terminal to provide a security reminder to the first user corresponding to the first terminal.

5. The method according to claim 1, wherein the second virtual resource information has a preset format, and the preset format is used for the second user to transfer virtual resource to the virtual resource receiving party.

6. The method according to claim 2, wherein the second virtual resource information or the third virtual resource information passing the risk verification of the cloud server comprises:
sending, by the first terminal, the second virtual resource information to the cloud server in a form of a link or a QR code, and/or sending, by the second terminal, the third virtual resource information to the cloud server in a form of a link or a QR code; and
performing, by the cloud server, the risk verification on the second virtual resource information or the third virtual resource information.

7. The method according to claim 1, wherein the virtual resource comprises monetary resource.

8. A first terminal in a first domain, including:
at least one processor, and
a memory communicatively connected with the at least one processor, wherein the memory stores instructions executable by the at least one processor to cause the first terminal to perform operations comprising:
generating first virtual resource information according to virtual resource information provided by a first user, wherein the first virtual resource information at least includes a quantity of a virtual resource, information of the first user, and information of a virtual resource receiving party to receive the virtual resource, and the virtual resource receiving party is located in the first domain;
transmitting the first virtual resource information to a cloud server located in a second domain, causing the cloud server to generate second virtual resource information according to the first virtual resource information and return the second virtual resource information to the first terminal, wherein the second virtual resource information at least includes the first virtual resource information; and
sending the second virtual resource information to a second terminal of a second user located in the second domain, so that the second terminal transfers, based on the second virtual resource information, virtual resource corresponding to the quantity of the virtual resource to the virtual resource receiving party.

9. The first terminal according to claim 8, wherein the first terminal sending the second virtual resource information to the second terminal, so that the second terminal transfers, based on the second virtual resource information, the virtual resource corresponding to the quantity of the virtual resource to the virtual resource receiving party comprises:
receiving, by the second terminal of the second user, the second virtual resource information sent by the first terminal;
sending, by the second terminal, a resource transfer request to a server where virtual resources of the second user are located, causing the server where the virtual resources of the second user are located to select the virtual resource from the virtual resources of the second user and to transfer the virtual resource to the cloud server, and generating, by the second terminal, third virtual resource information to complete a first transfer of the virtual resource, wherein the third virtual resource information includes identity information of the second user; and
if the second virtual resource information or the third virtual resource information passes risk verification of the cloud server, transferring, by the cloud server, the virtual resource to the virtual resource receiving party to complete a second transfer of the virtual resource.

10. The first terminal according to claim 8, wherein:
the cloud server performs risk verification on the first virtual resource information;
in response to that the first virtual resource information passes the risk verification, the cloud server generates the second virtual resource information according to the first virtual resource information and returns the second virtual resource information to the first terminal.

11. The first terminal according to claim 10, wherein:
in response to that the first virtual resource information fails the risk verification at the cloud server, the cloud server returns a risk verification result to the first terminal to provide a security reminder to the first user corresponding to the first terminal.

12. The first terminal according to claim 8, wherein the second virtual resource information has a preset format, and the preset format is used for the second user to transfer virtual resource to the virtual resource receiving party.

13. The first terminal according to claim 9, wherein the second virtual resource information or the third virtual resource information passing the risk verification of the cloud server comprises:
sending, by the first terminal, the second virtual resource information to the cloud server in a form of a link or a QR code, and/or sending, by the second terminal, the third virtual resource information to the cloud server in a form of a link or a QR code; and
performing, by the cloud server, the risk verification on the second virtual resource information or the third virtual resource information.

14. One or more non-transitory computer-readable media configured with instructions executable by a virtual resource transfer system to cause the virtual resource transfer system to perform operations comprising:
generating, by a first terminal in a first domain, first virtual resource information according to virtual resource information provided by a first user, wherein the first virtual resource information at least includes a quantity of a virtual resource, information of the first user, and information of a virtual resource receiving party to receive the virtual resource, and the virtual resource receiving party is located in the first domain;
transmitting, by the first terminal, the first virtual resource information to a cloud server located in a second domain, causing the cloud server to generate second virtual resource information according to the first virtual resource information and return the second virtual resource information to the first terminal, wherein the second virtual resource information at least includes the first virtual resource information; and
sending, by the first terminal, the second virtual resource information to a second terminal of a second user located in the second domain, so that the second user transfers, based on the second virtual resource information, the virtual resource corresponding to the quantity of the virtual resource to the virtual resource receiving party.

15. The one or more non-transitory computer-readable media according to claim 14, wherein the first terminal sending the second virtual resource information to the second terminal, so that the second terminal transfers, based on the second virtual resource information, virtual resource corresponding to the quantity of the virtual resource to the virtual resource receiving party comprises:
receiving, by the second terminal of the second user, the second virtual resource information sent by the first terminal;
sending, by the second terminal, a resource transfer request to a server where virtual resources of the second user are located, causing the server where the virtual resources of the second user are located to select the virtual resource from the virtual resources of the second user and to transfer the virtual resource to the cloud server, and generating, by the second terminal, third virtual resource information to complete a first transfer of the virtual resource, wherein the third virtual resource information includes identity information of the second user; and
if the second virtual resource information or the third virtual resource information passes risk verification of the cloud server, transferring, by the cloud server, the virtual resource to the virtual resource receiving party to complete a second transfer of the virtual resource.

16. The one or more non-transitory computer-readable media according to claim 14, wherein the operations further comprise:
performing risk verification on the first virtual resource information at the cloud server; and
in response to that the first virtual resource information passes the risk verification, generating, by the cloud server, the second virtual resource information according to the first virtual resource information and returning, by the cloud server, the second virtual resource information to the first terminal.

17. The one or more non-transitory computer-readable media according to claim 16, wherein the operations further comprise:
in response to that the first virtual resource information fails the risk verification at the cloud server, returning a risk verification result to the first terminal to provide a security reminder to the first user corresponding to the first terminal.

18. The one or more non-transitory computer-readable media according to claim 14, wherein the second virtual resource information has a preset format, and the preset format is used for the second user to transfer virtual resource to the virtual resource receiving party.

19. The one or more non-transitory computer-readable media according to claim 15, wherein the second virtual resource information or the third virtual resource information passing the risk verification of the cloud server comprises:
sending, by the first terminal, the second virtual resource information to the cloud server in a form of a link or a QR code, and/or sending, by the second terminal, the third virtual resource information to the cloud server in a form of a link or a QR code, and
performing, by the cloud server, the risk verification on the second virtual resource information or the third virtual resource information.

20. The one or more non-transitory computer-readable media according to claim 14, wherein the virtual resource comprises monetary resource.
